(19) United States
(12) Patent Application Publication
(10) Pub. No.: US 2026/0084945 A1
(43) Pub. Date: Mar. 26, 2026

(54) BATTERY-POWERED ELECTRIC HANDLING VEHICLE

(71) Applicant: MANITOU BF, ANCENIS (FR)

(72) Inventors: Pierre BERTRAND, ANCENIS (FR); David LEON, ANCENIS (FR); Benoît GASCHET, ANCENIS (FR)

(21) Appl. No.: 19/305,074

(22) Filed: Aug. 20, 2025

(30) Foreign Application Priority Data
Sep. 23, 2024 (FR) 2410114

(51) Int. Cl. B66F 9/065; B60K 1/04; B60L 50/60; B66F 9/075

(52) U.S. Cl. CPC B66F 9/065; B60K 1/04; B60L 50/66; B66F 9/07531; B66F 9/07568; B60K 2001/0416; B60L 2200/42

(57) ABSTRACT

Handling vehicle (1) comprising a chassis (2), an arm (5) coupled by a pivot link (6) to the rear of the chassis for a pivoting movement between a lower position and an upper position, a front set (7) of steered wheels (8), a rear set (9) of steered wheels (10), an electric drive unit for the steered wheels (8; 10) which is powered by a battery (11).

The battery (11) is arranged at least partially below the arm (5), a first part of the battery (11) extends on the vehicle (1) in front of the pivot axis of the pivot link (6) of the arm (5) to the chassis, a second part of the battery (11) extends on the vehicle (1) behind the pivot axis of the pivot link (6) of the arm (5) to the chassis, and the battery (11) is arranged inside the turning circle.

The present invention relates to the field of load handling.

In particular, the invention relates to a load handling vehicle with a pivoting arm.

In order to reduce the environmental impact of a handling vehicle with a pivoting arm, it is known to use an electric drive.

The use of an electric drive generally entails the installation of a battery on the vehicle with a sufficient capacity to supply the energy at a given use cycle of the machine, for example a whole day.

Nevertheless, the battery must not impair the performance of the machine or safety when the vehicle is manoeuvring. In particular, when a vehicle with an internal combustion engine is modified to install an electric drive, the behaviour and the conditions of use of the modified vehicle must be similar to those of the vehicle prior to the modifications.

An object of the invention is to make available an electric handling vehicle with an arm, the behaviour and the use conditions of which are similar to those of a vehicle with an internal combustion engine with an arm.

To this end, the subject of the invention is a handling vehicle comprising a chassis with a front part and a rear part, an arm extending longitudinally in a front-to-rear direction of the chassis and coupled by a pivot link to the rear of the chassis for a pivoting movement between a lower position and an upper position,
a front set of steered wheels, a rear set of steered wheels, an electric drive unit for the steered wheels of the front set and the rear set, the drive unit being powered by a battery,
each wheel of the front set and the rear set being mounted as movable in rotation between a maximum steered position to the right and a maximum steered position to the left, the positioning of the wheels of the front set in one of the maximum steered positions and the positioning of the wheels of the rear set in the other of the maximum steered positions enabling the movement of the vehicle in a minimum circular trajectory, the circle which passes through the wheel of the front set and the wheel of the rear set on the outside of the trajectory when the vehicle is moving in the minimum circular trajectory defining a turning circle;
characterized in that the battery is arranged at least partially below the arm, in that a first part of the battery extends on the vehicle in front of the pivot axis of the pivot link of the arm to the chassis, in that a second part of the battery extends on the vehicle behind the pivot axis of the pivot link of the arm to the chassis, and in that the battery is arranged inside the turning circle.

The specific positioning of the battery below the arm, with a first part of the battery extending on the vehicle in front of the pivot axis of the link of the arm to the chassis and a second part of the battery extending on the vehicle behind the pivot axis of the pivot link of the arm to the chassis, makes it possible to ensure good balancing of the masses on the vehicle and ensures good visibility for completely safe load handling.

Moreover, the fact that the battery is arranged inside the turning circle makes it possible not to obstruct the turning movements of the vehicle.

The vehicle preferably has a height and a width which are less than 2.50 m, in particular less than 2.10 m.

The battery can have a capacity between 30 KWh and 50 KWh.

In one embodiment of the invention, the battery is accessible from the rear of the vehicle. Such a position allows simple and quick maintenance to be performed on the battery.

In one embodiment of the invention, a part of the battery extends so that it overhangs at the rear of the chassis.

In one embodiment of the invention, the overhanging part of the battery comprises a bottom face, a rear face and an inclined linking wall between the bottom face and the rear face with a slope downward from the rear part of the chassis to the front part of the chassis.

Such an inclined wall makes it possible to ensure a good ground clearance capacity of the vehicle without risking damage to the battery.

In one embodiment of the invention, the inclined wall extends in a plane forming an angle of between 20° and 40° with a ground contact plane of the vehicle at a point in time when the latter is moving over a flat surface.

In one embodiment of the invention, the wheels of the rear set are interconnected by an axle, the battery being at least partially arranged on the vehicle behind the axle.

In one embodiment of the invention, the battery is mounted removably on the vehicle.

In one embodiment of the invention, the battery is arranged on either side of a central longitudinal plane of the vehicle, preferably substantially symmetrically on either side of the said central longitudinal plane. This makes it possible to improve the balancing of the masses on the vehicle.

In one embodiment of the invention, where the battery has a first portion extending on one side of the central longitudinal plane of the vehicle and a second portion extending on the opposite side, referred to as the second side, of the central longitudinal plane of the vehicle, the ratio between the mass M1 of the first portion extending on the first side of the central longitudinal plane of the vehicle and the mass of the second portion extending on the second opposite side of a central longitudinal plane of the vehicle is between 1 and 0.8.

### BRIEF DESCRIPTION OF THE DRAWINGS

The invention will be readily understood upon reading the following description of exemplary embodiments with reference to the attached drawings, in which:

FIG. 1 is a perspective schematic view of a handling vehicle according to the invention,

FIG. 2 is a view from above of the vehicle in FIG. 1,

FIG. 3 is a view from below of the vehicle in FIG. 1,

FIG. 4 is a view similar to that in FIG. 3 in which the wheels are turned, and

FIG. 5 is a partial side view of the rear part of the vehicle in FIG. 1, one wheel and a left-hand side of the chassis being omitted.

In the description which follows, identical elements or identical functions have the same reference signs. In order to make the present description concise, they are not described with regard to each of the figures, only the differences between the embodiments being described.

The actual proportions have not always been respected in the figures for the sake of clarity.

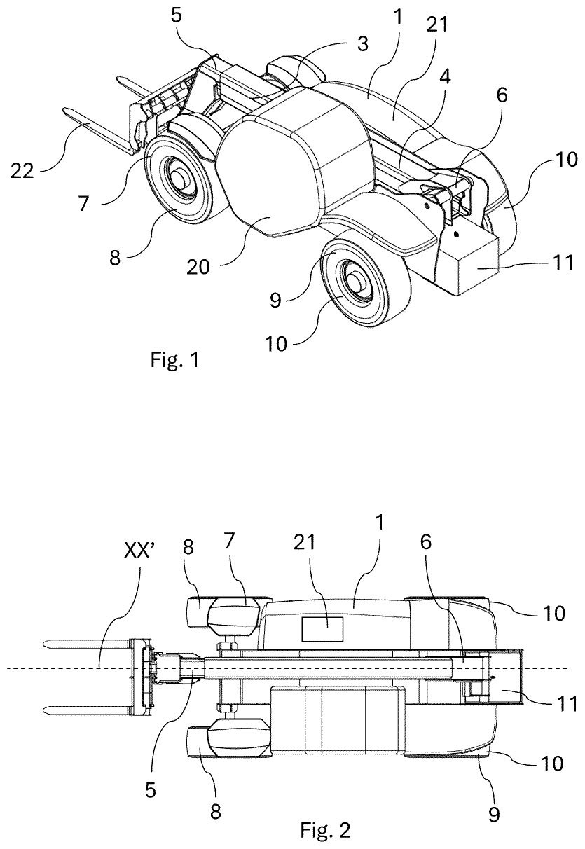

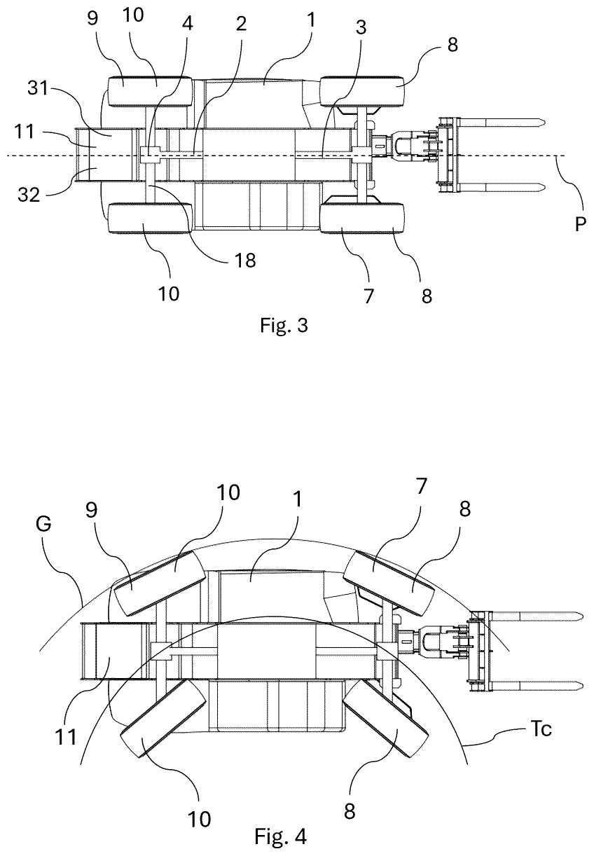

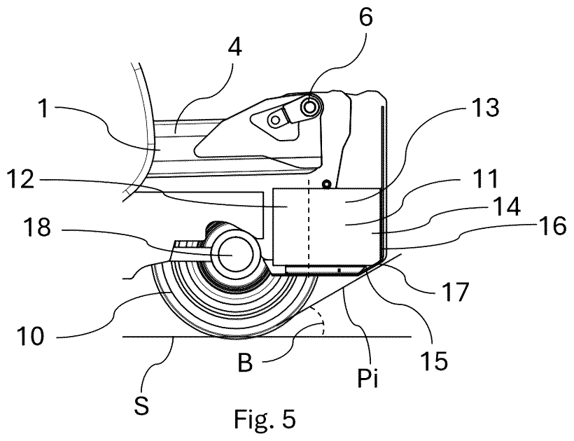

Illustrated in FIGS. 1 to 5 is an example of a load handling vehicle 1 according to the invention, in this example a small vehicle 1 with a height and width under 2.50 m, in particular under 2.10 m. The invention nevertheless applies to vehicles with larger dimensions. In particular, this vehicle can have a length in the order of 4.70 m, a width in the order of 2 m and a height close to 2 m.

The vehicle 1 comprises a chassis 2 with a front part 3 and a rear part 4. The vehicle 1 can move forwards in a direction from the rear part 4 toward the front part 3, and backwards in a direction from the front part 3 towards the rear part 4.

In this example, the vehicle 1 comprises a cabin 20 in which an operator can be positioned in order to drive the vehicle 1. Alternatively, the vehicle 1 could have no cabin, for example being remote-controllable.

The vehicle 1 comprises an arm 5 extending longitudinally in a front-to-rear direction XX′ of the chassis 2. The arm 5 is coupled by a pivot link 6 to the rear of the chassis 2, in other words on the rear part 4, so that it can move pivotably between a lower position and an upper position.

The vehicle 1 comprises a front set 7 equipped with steered wheels 8, and a rear set 9 which is also equipped with steered wheels 10. The steered wheels 8, 10 of the front set 7 and the rear set 9 are driven by an electric drive unit powered by a battery 11. The electric drive unit also comprises one or more electric motors 21, for example arranged between the front set 7 and the rear set 9, in particular positioned entirely or partially below the arm 5 or opposite the cabin 20 with respect to the central longitudinal plane P of the vehicle 1. The motor or motors 21 can extend longitudinally or transversely. Each wheel 8, 10 of the front set 7 and the rear set 9 can move in rotation between a maximum steered position to the right and a maximum steered position to the left. By way of illustration, in FIG. 4 the wheels 8 of the front set 7 are in the maximum steered position to the left and the wheels 10 of the rear set 9 are in the maximum steered position to the right.

Positioning the wheels 8 of the front set 7 in one of the maximum steering positions and positioning the wheels 10 of the rear set 9 in the other of the maximum steering positions, as in FIG. 4, allow the vehicle 1 to move in a minimum circular trajectory Tc, in other words the smallest circle that the vehicle 1 can make.

A turning circle G of the vehicle 1 is defined by the circle which passes through the wheel of the front set 7 and the wheel of the rear set 9 on the outside of the trajectory when the vehicle 1 moves in this minimum circular trajectory Tc. In particular, the centre of the turning circle G coincides with the centre of the minimum circular trajectory Tc.

The battery 11 is arranged below the arm 5, thus ensuring good visibility for the manoeuvres of the vehicle 1. A first part 12 of the battery 11 extends on the vehicle 1 in front of the pivot axis of the pivot link 6 of the arm 5 on the chassis 2, whilst a second part 13 of the battery 11 extends on the vehicle 1 behind the pivot axis of the pivot link 6 of the arm 5 on the chassis 2.

Generally, the battery 11 is arranged on either side of a central longitudinal plane P of the vehicle 1, preferably symmetrically on either side of the said central longitudinal plane P. In particular, where the battery 11 has a first portion 31 extending on a first side of the central longitudinal plane P of the vehicle 1 and a second portion 32 extending on the second opposite side of the central longitudinal plane P of the vehicle 1, the ratio between the mass M1 of the first portion 31 extending on the first side of the central longitudinal plane P of the vehicle 1 and the mass M2 of the second portion 32 extending on the second opposite side of a central longitudinal plane P of the vehicle 1 is between 1 and 0.8.

This arrangement ensures that the mass of the battery 11 is well distributed over the vehicle 1. Furthermore, this position makes it possible to provide a counterweight to the load carried by a tool 22 in front of the arm 5.

The wheels 10 of the rear set 9 are interconnected by an axle 18, the battery 11 being at least partially arranged on the vehicle 1 behind the axle 18.

The battery 11 is also arranged inside the turning circle G. This makes it possible not to obstruct the turning movements of the vehicle 1 irrespective of the direction of movement of the vehicle 1, in particular when the vehicle 1 moves along the minimum circular trajectory Tc, facilitating the use of the vehicle 1.

The battery 11 is accessible from the rear of the vehicle 1 and can be mounted removably, which facilitates its maintenance.

In this example, a part 14 of the battery 11 extends so that it overhangs at the rear of the chassis 2. So as not to limit the ground clearance capacities of the vehicle 1, this overhanging part 14 of the battery 11 comprises a bottom face 15, a rear face 16 and an inclined linking wall 17 between the bottom face 15 and the rear face 16 with a slope downward from the rear part 4 of the chassis 2 to the front part 3 of the chassis 2. The inclined wall 17 extends in a plane Pi forming an angle B of between 20° and 40° with a ground contact plane S of the vehicle 1 at a point in time when the latter is moving over a flat surface.

1. Handling vehicle (1) comprising a chassis (2) with a front part (3) and a rear part (4), an arm (5) extending longitudinally in a front-to-rear direction (XX′) of the chassis (2) and coupled by a pivot link (6) to the rear of the chassis (2) for a pivoting movement between a lower position and an upper position, a front set (7) of steered wheels (8), a rear set (9) of steered wheels (10), an electric drive unit for the steered wheels (8; 10) of the front set (7) and the rear set (9), the drive unit being powered by a battery (11),
each wheel (8; 9) of the front set (7) and the rear set (9) being mounted as movable in rotation between a maximum steered position to the right and a maximum steered position to the left, the positioning of the wheels (8) of the front set (7) in one of the maximum steered positions and the positioning of the wheels (10) of the rear set (9) in the other of the maximum steered positions enabling the movement of the vehicle (1) in a minimum circular trajectory (Tc), the circle which passes through the wheel of the front set (7) and the wheel of the rear set (9) on the outside of the trajectory when the vehicle (1) is moving in the minimum circular trajectory (Tc) defining a turning circle (G);
characterized in that the battery (11) is arranged at least partially below the arm (5), in that a first part (12) of the battery (11) extends on the vehicle (1) in front of the pivot axis of the pivot link (6) of the arm (5) to the chassis (2), in that a second part (13) of the battery (11) extends on the vehicle (1) behind the pivot axis of the pivot link (6) of the arm (5) to the chassis (2), and in that the battery (11) is arranged inside the turning circle (G).

2. Vehicle (1) according to claim 1, characterized in that the battery (11) is accessible from the rear of the vehicle (1).

3. Vehicle (1) according to one of claims 1 and 2, characterized in that a part (14) of the battery (11) extends so that it overhangs at the rear of the chassis (2).

4. Vehicle (1) according to the preceding Claim, characterized in that the overhanging part (14) of the battery (11) comprises a bottom face (15), a rear face (16) and an inclined linking wall (17) between the bottom face (15) and the rear face (16) with a slope downward from the rear part (4) of the chassis

(2) to the front part (3) of the chassis (2).

5. Vehicle (1) according to the preceding claim, characterized in that the inclined wall (17) extends in a plane (Pi) forming an angle (B) of between 20° and 40° with a ground contact plane (S) of the vehicle (1) at a point in time when the latter is moving over a flat surface.

6. Vehicle (1) according to one of the preceding Claims, characterized in that the wheels (10) of the rear set (9) are interconnected by an axle (18), the battery (11) being at least partially arranged on the vehicle (1) behind the axle (18).

7. Vehicle (1) according to one of the preceding Claims, characterized in that the battery (11) is mounted removably on the vehicle (1).

8. Vehicle (1) according to one of the preceding Claims, characterized in that the battery (11) is arranged on either side of a central longitudinal plane (P) of the vehicle (1), preferably substantially symmetrically on either side of the said central longitudinal plane (P).

9. Vehicle (1) according to claim 8, characterized in that, where the battery (11) has a first portion extending on one side of the central longitudinal plane (P) of the vehicle (1) and a second portion extending on the opposite side, referred to as the second side, of the central longitudinal plane (P) of the vehicle (1), the ratio between the mass M1 of the first portion extending on the first side of the central longitudinal plane (P) of the vehicle (1) and the mass (M2) of the second portion extending on the second opposite side of a central longitudinal plane (P) of the vehicle (1) is between 1 and 0.8.
